(19) United States
(12) Patent Application Publication
(10) Pub. No.: US 2003/0149601 A1
(43) Pub. Date: Aug. 7, 2003

(54) Network billboard system and method thereof

(76) Inventor: Anthony J. Cabral, Philadelphia, PA (US)

Correspondence Address: Caesar, Rivise, Bernstein, Cohen & Pokotilow, Ltd., 12th Floor, Seven Penn Center, 1635 Market Street, Philadelphia, PA, 19103-2212, US

(21) Appl. No.: 09/737,017

(22) Filed: Dec. 14, 2000

(51) Int. Cl. G06F 17/60

(52) U.S. Cl. 705/5

(57) ABSTRACT

A network billboard system supports an application program and a network of computing devices including a server, database, billboard computer and client computer. The system administers, delivers, and disseminates data files (eg., advertisements) manually and/or automatically via the network and a publically accessible schedule or other triggering event to display data on a public structure (e.g., electronic billboard, projection system) or personal electronic device.

### SPECIFICATION

### FIELD OF THE INVENTION

This invention relates to a tool and technique for combining the dynamic and interactive features of network systems with mass public advertisement. In particular, this invention relates to a network billboard system (NBS) and method for using the system (e.g., scheduling, transferring and displaying advertisements to at least one billboard).

### BACKGROUND OF THE INVENTION

Billboards are used to display various messages (e.g., advertisements), usually including a combination of graphics and text. Billboards have appeared in the U.S. for more than 100 years in one form or another and have an important economic impact in the U.S. Billboards have been shown to be an effective method to penetrate economic markets and create brand awareness.

Generally, the messages are provided as fixed sheets plastered to a hard, flat backing. The messages are generally displayed for a long period of time (eg., weeks, months) to create brand awareness and because replacing a billboard display is time consuming and expensive. Sheets may cost in the range of $900 to $1,500 to produce each. A crew is typically required to change a sheet or paste another sheet over the existing sheet, which is labor intensive and slow. Moreover, for the safety of the crew, billboard displays are not changed in bad weather.

Typically, advertisers contract the advertisement for display at various billboard locations in agreed upon sequences and intervals to penetrate and extend market reach. However, labor and cost constraints do not allow frequent (eg., daily), quick, and easy change of advertisements and location, thus, reducing effective penetration of a market. Accordingly, a need exists to facilitate posting advertisements in different locations and times to target audiences effectively.

Electronic billboards are becoming more popular, for example, at sporting arenas and along downtown buildings. The electronic billboards provide the advantage in that the advertising displays can be easily and quickly changed.

Companies that advertise on the Internet typically forwarded their advertisements to end user terminal computers connected online. The advertisements are generally placed along the borders of a web page, so the computer user can continue to operate in the Internet, even when the advertisements are placed around the border of the screen. Unfortunately, the advertisements are generally seen only by the persons able to observe the computer screens. Accordingly, a need exists to extend the web and multimedia advertisement to a billboard model. In particular, a need exists to combine dynamic and interactive features of network systems with mass public advertisement.

The projection or display from the web onto a billboard is different than the display from a desktop PC to a monitor. Exploiting the strength of a network backbone to billboard advertising requires unique structure and network programming challenges. Namely, software must be written to receive customer input, incorporate customer input, and locate transfer, and disseminate files (such as advertisements) based on information supplied by customers and according to a time table. The software must communicate data synergistically among possibly remote devices based on different operating system platforms and application protocols (eg., HTTP, FTP, JDBC, SMTP) within the network. In addition, the software must also disseminate data outside the network to a disparity of computing devices, serve requests from multiple sources simultaneously, and ensure network security.

In addition to the underlying network structure requirements, a physical and public structure is needed to support the invention. As examples, the structure must insulate and maintain environment conditions needed for the billboard system to operate, engineer shading for image quality, and protect the system from vandalism. There is no known medium readily available that addresses these challenges to enable an individual to use web centric tools and infrastructure for mass public billboard advertisement.

### SUMMARY OF THE INVENTION

The present invention discloses a network billboard system and method for using this system. The billboard system is a computer controlled, interactive, indoor/outdoor display system, based on a network centric platform. The system operates in a network environment (eg., virtual private network (VPN), local area network (LAN), wide area network (WAN), world wide web (www), etc.) to provide remote access and other features described below. The system can have one or multiple displays, each operating independently, as one unit or as subnetworks of billboards within a larger network.

A billboard can feature an advertisement from one company or can be time shared. Individuals can remotely check billboard activity, update the billboard schedule, transfer files, choose from advertisement templates, conduct payment transactions, and/or connect to the website of sponsors featured in the advertisement for more information. Individuals can also “hotsync” with the billboard to view and/or download customer (eg., sponsor) information to a personal digital assistant (PDA) or other mobile display device. The observers can hotsync with the billboard either by wireless communication via a conduit device on the billboard or by wire/wireless communication at a terminal computer.

Billboard content can reside in a central location or distributed throughout the network. After a predetermined elapsed time (e.g., 6 hours, 12 hours, 24 hours), an application program will initiate and automatically access a schedule and locate and configure files containing advertisement content for routine delivery to the billboard based on the schedule. Alternatively, the schedule can be mutually accessed (eg., printed) and advertisement content manually located and configured following the schedule for routing delivery to the billboard. In either case, the schedule is accessible to customers for customization.

It will be appreciated that it is an aspect of the present invention to provide a network billboard system including at least one electronic billboard, a network controller, a storage device and an approach for advertising on the billboard.

A feature of the present invention is to provide a method for reserving advertisement space for a customer on the at least one billboard. Another feature is to allow customers to advertise efficiently on billboards according to market research and demographic data. Preferably, the method includes a network billboard system receiving a request to reserve an advertising space via the network controller, the request including at least one electronic billboard, a start date and a contract period. The method further includes locating a billboard schedule in the storage device for the requested billboard, determining whether the requested billboard has an available slot on the requested start date or finding an available slot on a date closest to the requested start date, reserving the available slot corresponding to the requested start date or the date closest to the requested start date, and committing the available slot for the requested contracted period. When the advertisement space is reserved, the network billboard system notifies the customer that the transaction is confirmed.

Another feature of the present invention is to provide a distributed programming application for placing advertisements on at least one billboard. Preferably, the programming application includes accessing a schedule table for at least one of the billboards, the table having an identification of customers for time slots for future dates. The application feasibly links to further tables in a relational database holding additional customer information such as demographic or market research data that a customer desires to include. The programming application extracts information contained in the table(s) and proceeds to locate, prepare, and deliver the advertisement files throughout the network and to the billboards as needed.

In another preferred embodiment, the programming application transmits an advertisement signal to the at least one billboard, the advertisement signal indicating a picture for display at the billboard based on the customer identification for the current time slot. Upon receipt of a request from a party, the application provides access to information of goods or services by the customer, the information provided to the requested party.

The network billboard system is a distributed programming application based on a client/server model where the billboard computer and user terminals are the clients and communicate with servers, and a database in a single or multi-tier architecture. The network billboard system includes billboard computers in communication with a network server (e.g., web server and application server) and receives markup language (eg., Hypertext Markup Language (HTML), Extensible Markup Language (XML)) files that embed or reference advertisement files (eg., still or moving picture files, such as Shockwave Flash movie files) from a temporary or “working” folder in a scheduling loop. The network server manages multiple connections to the schedule and its database by server-side application programs, written primarily with a programming language (eg., Java, Server-side Javascript, C++, etc.) using a socket communication protocol (eg., User Datagram Protocol (UDP), Transmission Control Protocol (TCP)), a network protocol (eg., Internet Protocol (IP)), and an application protocol (eg., Hypertext Transfer Protocol (HTTP), File Transfer Protocol (FTP), Simple Mail Transfer Protocol (SMTP), Java Database Connectivity Protocol (JDBC), etc.) to communicate data streams or datagrams.

Another feature of the present invention is to provide a method for customers to interact with the billboard. Persons connecting remotely from the world wide web or a point-of-sale terminal (eg., terminal computer) to the web server can visit the website or a website directory for more information of the sponsors. The sponsors can feasibly transfer from, for example, the world wide web or from terminals, advertisement content created by the sponsors to a directory for eventual display on the billboard. Sponsors (eg., customers) can also access and update the schedule of a billboard via client-side programs (e.g., applets) and server-side programs (e.g., servlets, JavaServer Pages, JavaBeans, etc.) to reserve space for display of content transferred by the customers. Sponsors may also include demographic and market research data to most effectively target consumers.

Server-side application programs managed by the network server use application programming interfaces (APIs) (e.g., Java Developers Kit (JDK), Java Servlet Developers Kit (JSDK), Enterprise Javabeans (EJB), Remote Method Invocation (RMI), Java Database Connectivity (JDBC)) available to a programming language (eg., Java 2 Platform Enterprise Edition (J2EE)) to access the schedules in a data source (eg. tables in a relational database), extract information, and locate, modify, and transfer media files stored in a data source for dissemination by the billboard computer.

### BRIEF DESCRIPTION OF THE DRAWINGS

The invention will be described in conjunction with the following drawings in which like-referenced numerals designate like elements and wherein:

FIG. 1 is a block diagram depicting an exemplary network configuration used to implement the network billboard system of a preferred embodiment of the invention;

FIG. 2 is a block diagram depicting an exemplary data processing architecture of a terminal computer which is employed to implement the network billboard system of a preferred embodiment of the invention;

FIG. 3 illustrates an exemplary billboard arranged for displaying advertisements in accordance with a preferred embodiment of the invention;

FIG. 4 illustrates an exemplary schedule table for a particular billboard in accordance with a preferred embodiment of the invention;

FIG. 5 shows an exemplary flowchart illustrating steps for updating a schedule, for example, as shown in FIG. 3; and

FIG. 6 shows a flow chart illustrating steps for performing a dynamic schedule application.

### DETAILED DESCRIPTION OF PREFERRED EMBODIMENTS

The network billboard system (NBS) is a configuration supporting an application program or programs and a computing device or a network of such computing devices. The computing devices may be located at a local or remote site. The network billboard system administers, delivers and disseminates data files (eg., advertisements including still pictures, moving pictures, streaming video, text) manually and/or automatically via computer programs and a publically accessible schedule or other triggering event to a device to display data on a public structure (eg., electronic billboard) or personal electronic device.

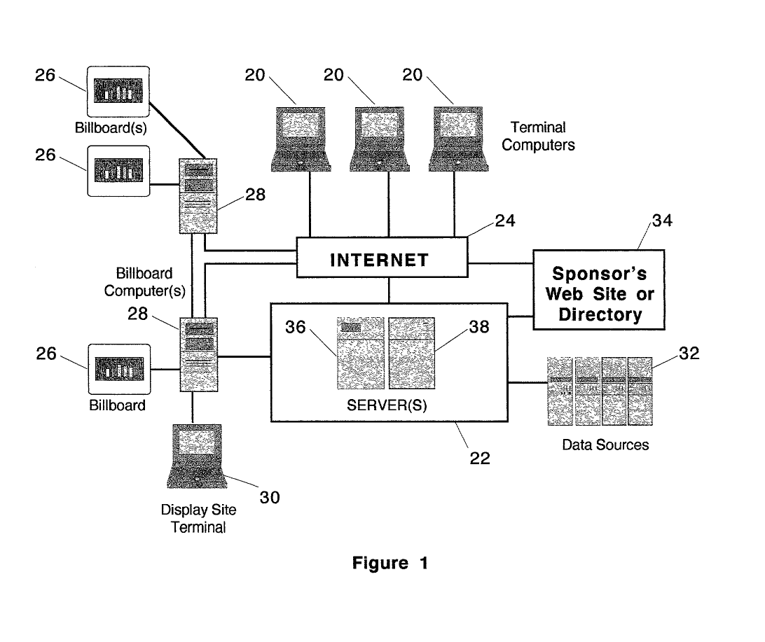

Referring now in greater detail to the various figures of the application, wherein like referenced characters refer to like parts, a general exemplary network billboard system 10 of the invention is illustrated in FIG. 1. The NBS 10 is illustrated as an Internet online environment including terminal computers 20, a network server 22, the Internet 24, billboards 26, billboard computers 28, a display site terminal 30, a data source 32, and a sponsor's website or directory 34. Supporting network hardware (e.g., routers, HUBS) are not shown but included in the NBS system 10 as readily understood by a skilled artesian.

Terminal computers 20 (also referred to as “terminals”) communicate with the network server 22 and preferably a database via the Internet 24. Typically, the terminal computers 20 access the Internet through an Internet service provider (eg., Earthlink) or through an Internet access provider (eg., Erols, America On Line, etc.) via a communications interface (eg., modem, cable, telephone line, satellite dish, etc.) and the Internet access provider accesses the Internet 24.

The network server 22 can include several servers, including a web server 36 and an application server 38. The web server 36 and application server 38 may include one server or several servers, such as proxy servers and firewalls (to implement security measures), FTP servers, SMTP servers, media servers (eg., Macromedia Generator, RealNetworks Media server), etc. The servers cooperate with each other to operate the application program or programs, as described in greater detail below. The network server 22 is preferably accessed by a user or customer via an Internet protocol (IP) address. Each billboard 26 communicates with a billboard computer 28, which communicates with the network server 22 preferably through the Internet 24. The terminal computers 20, the display site terminal 30, the network server 22 and the billboard computers 28 communicate according to the protocol supported by the world wide web of the Internet via data packets having a transmission control protocol/Internet protocol (TCP/IP) format.

The terminal computers 20 and display site terminal 30 include Internet access devices (eg., personal digital assistants (PDAs), cell phones, pagers, notebook computers, televisions) that preferably include an input device (eg., keyboard, mouse, tract ball, joy stick, microphone, pin, the like, or combinations thereof), an output device (e.g., video monitor or screen, including CRTs), and a network interface (eg., a modem, communication medium, web browser) for transferring user and customer inputs via the input device to the network server 22.

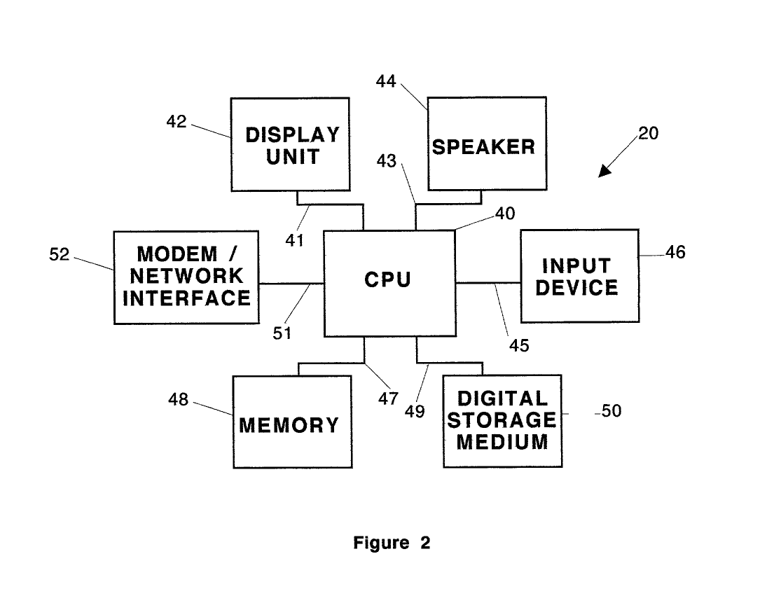

FIG. 2 illustrates a block diagram representing a typical embodiment of a terminal computer 20 (or display site terminal 30) capable of supporting the network billboard system of the preferred embodiments of the invention. The terminals 20, 30 include a central processing unit (CPU) 40 that can process video and sound data as well as other operations required to run the terminals. It is understood that a task of the CPU 40 can be performed by a single microprocessor or a number of microprocessors.

The exemplary terminals 20, 30 also include a display unit 42 connected via lines 41 to the CPU 40 having a size and resolution sufficient to project visual images output via the CPU 40. The display unit 42 is generally a high resolution screen or CRT. An output device (eg., speaker 44) is connected via lines 43 to the CPU 40 for producing an output (eg., sounds associated with an image at the display unit 42 or an advertisement). As shown in FIG. 2, the CPU 40 is also connected via lines 45 to input device 46; via lines 47 to memory 48; via lines 49 to a digital storage medium 50; and via lines 51 to a modem/network interface 52. The lines 41, 43, 45, 47, 49, 51 may be physical wires or wireless conduits (eg., infra-red, laser, optical, electrical, etc.).

The input device 46 can be a keyboard, mouse, microphone, joystick, pin, button, or combination of these devices, depending on how the user or customer decides to enter his or her inputs. Memory 48 is in communication with the CPU 40 to store and provide data required by the CPU 40 to operate the terminals 20, 30. The digital storage medium 50 stores electronic instructions and software necessary for addressing and operating the network billboard system from the terminals 20, 30. The digital storage medium can be a hard disc, compact disc, floppy disc, cartridge, network storage unit, any combination thereof, or any other memory capable of storing the electronic instructions and software. As noted above, the modem/network interface 52 provides the communication medium between the terminals 20, 30 and a network server 22 or Internet 24. The interface 52 can include a modem or a network interface, for example, electrical wire, satellite signal processor, optical fiber, or a web browser used for linking the terminal 20, 30 to the web server 36 according to a transfer protocol (e.g., TCP/IP).

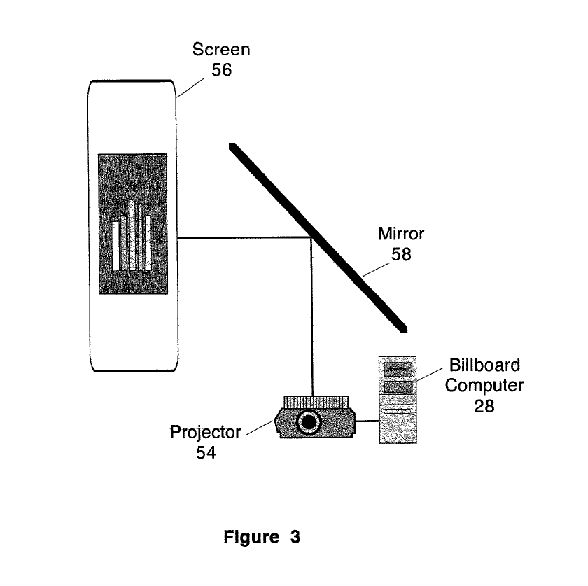

FIG. 3 shows an exemplary billboard 26 and billboard computer 28 in accordance with a preferred embodiment of the invention. As shown, the billboard 26 is an electrical billboard that displays an image. The billboard 26 is preferably an LCD projector, as shown in FIG. 3. Another example of a billboard 26 is a large flat screen, such as an LCD panel, connected to a billboard computer 28 that is connected to a network server 22 either directly or via the Internet 24 with supporting network hardware such as routers, HUBs, etc.

The exemplary billboard 26 and computer 28 shown in FIG. 3 include an LCD projector 54, in video communication with a screen 56 via a mirror 58. The billboard computer 28 communicates with the billboard 26 via cable or wireless technology. Preferably the LCD projector 54 includes a plurality of lumens (eg., 3000 lumens) and a long throw zoom lens. The LCD projector 54 communicates with and is arranged to serve as the display unit for the billboard computer 28. The projector 54 is preferably kept in an enclosed area for isolation from the environment external to the billboard 26. Preferably the mirror 58 also is placed in the enclosed area, such that it reflects an image projected by the LCD projector 54 to the screen 56. The mirror 56 can be used for increasing the path length of the video image to increase the projection size of the image while in a limited space.

The billboard computer 28 preferably has a programming language (e.g., Java and Javascript) enabled web browser (eg., Netscape) with necessary plug-ins from different multimedia vendors and necessary application protocols (e.g., HTTP, FTP, etc.). The web browser is capable of reading markup language (e.g., HTML, XML) data. The billboard computer 28 preferably connects to a web server and “pulls” the markup language files that embed or reference advertisement files (e.g., still or moving picture files) and supporting client-side and server-side programs from the server 22. The billboard computer 28 is preferably a general purpose computer or PC. In particular, the billboard computer 28 includes a CPU 40, memory 48, digital storage medium 50, and modem/network interface 52, as disclosed above for terminals 20, 30 and shown in FIG. 2.

The billboard computer 28 preferably includes sufficient memory and storage medium to provide a good cache memory as a generous buffer to store numerous packets of the display and scheduling information. With a sufficiently large cache memory, the billboard computer 28 does not need to pull markup language files from its hard drive and server as often as would be needed if the billboard computer 28 had a small cache or no cache memory, thereby providing better efficiency to the network billboard system 10. Feasibly, the billboard computer 28 can also support application serving software to provide server functionality.

The network server 22 manages connections to media files, databases, and markup language pages, etc., as discussed in more detail below. As shown in FIG. 1, the network server 22 includes a web server 36 and an application server 38 when the network server 22 is in an Internet online environment. The web server 36 (e.g., Sun, IBM, Dell, Compac) runs software (e.g., iplanet web server, Apache) on an operating system (eg., Sun Solaris OE, Microsoft Windows NT, Hewlett Packard HP-UX, IBM AIX) to control the connections to the requested pages and embedded client-side and server-side files. The application server 38 (eg., Sun, IBM, Dell, Compac) executes software (eg., iPlanet Application Server, Netscape Application Server, RealNetworks Media Server, Macromedia Generator, etc.) on an operating system (eg., Sun Solaris OE, Microsoft Windows NT, Hewlett Packard HP-UX, IBM AIX) to control the connections to non-markup language files. Together, the web server 36 and application server 38 organizes, accesses and executes files required to operate the network billboard system 10. The web server 36 is used to access the web pages (e.g., markup language (e.g., HTML, XML) files) that embed client-side, server-side, and “working” media files, as described in greater detail below. The application server 38, preferably accesses server-side programs, “stored” media files, and schedules as described in greater detail below.

Some server-side application programs are managed by the application server 38. The programs use sockets to manage connections between the data base and web server 36. In particular, the application programs access the appropriate table or tables in the database (e.g., the schedule), extract information from the schedule, and prepare the stored media files for transfer to the working folder. The sockets are the terminal points at, for example, the servers 36, 38, the data source 32, the billboard computer 28, etc., where data is read from and sent to. Sockets also define the interface where terminals connect to a network/server to receive and send data. In summary, the sockets identify ports of the computer devices that are maintained until all the packets of information are delivered.

The data source 32 shown in FIG. 1 preferably stores the media files, the schedule and/or database used for disseminating advertisements. The data source 32 can consist of several computers (e.g., Sun Solaris OE, Microsoft Windows NT, Hewlett Packard HP-UX, IBM AIX), including a relational database. Preferably the database runs a programming language (eg., Structured Query Language (SQL)) enabled database server software (e.g., Oracle 8i, Sybase, Microsoft SQL Server, Informix, mySQL), interfaces (eg., JDBC-ODBC (Open Database Connectivity) bridge driver) and an application protocol (e.g., Java Database Connectivity (JDBC) protocol) for communicating with the network server 22 and its application programs. The data source 32 stores the media files, schedule (e.g., table in a relational database) and additional information associated with a customer for disseminating advertisements. The additional information may include, but is not limited to demographic research data and market research data.

The schedule is a routine by which ads are shown. For example, the schedule can be a loop created in a scripting language (eg., Java Script), a sequence of scenes in a video file, or a table or set of tables in a relational database preferably accessed by a server-side application program.

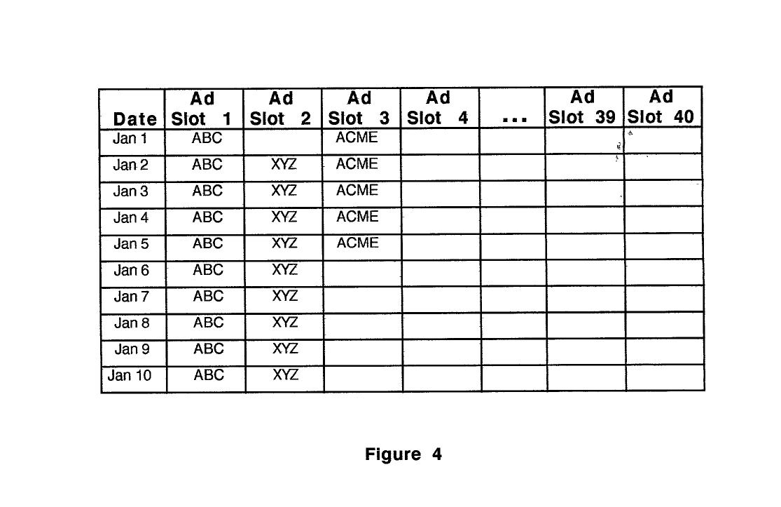

FIG. 4 shows an exemplary schedule table for a particular billboard 26 in the network billboard system 10. As shown, each row of the first column represents a day (e.g., Jan 1, Jan 2, Jan 3, etc.) and each column represents a time slot (e.g., ad slot 1, ad slot 2, ad slot 3, etc.) for the particular day. Each time slot indicates a customer that has reserved that corresponding slot for that date. In this preferred embodiment, the schedule keeps track of the billboard's availability by customer (e.g., abc, xyz, acme) for each contract period. The customer identifier (e.g., abc, xyz, acme) can be used to link to further tables in the data source 32 that hold additional data (e.g., demographic or market research data, reference to files, etc.) associated with a customer, as described in greater detail below. The additional data can involve several categories and descriptions, for example, goods or service sector, target age group, and target income bracket as shown in the following exemplary Table 1:

TABLE 1
Categories and Descriptions

| Customer ID | Goods/service sector | Age group | Income Bracket |
|---|---|---|---|
| ABC | Investing | 40-60 | $20,000-$40,000 |
| XYZ | College Sports | 20 to 35 | $20,000-$30,000 |
| ACME | Home Care | 40-50 | $40,000-$80,000 |

Based on the schedule, a number of advertisements (e.g., a series of Graphics Interchange Formats (GIFs), Flash movies) can be accessed for display on a particular billboard. In this example, each advertisement is shown in a loop with other advertisements. For example, forty 15-second advertisements can be shown in ten minutes and looped so that the advertisements should repeat every ten minutes. Other scenarios are possible, as desired. In this exemplary scenario, a billboard 26 can show advertisements for forty customers every ten minutes, thus increasing the value of the billboard 26 as compared to a prior art billboard that shows pasted sheets or panels until the sheets or panels are replaced by a crew.

Furthermore, as more billboards 26 are connected, billboards distributed throughout a region can access the same advertisement for display or alternate the location of the advertisement for targeting audiences more effectively based on demographic and market research data provided by customers for example in the scheduling procedure. This approach for targeting audiences according to demographic and market data increases the value of the NBS 10 as compared to prior art billboards that can not rotate ads frequently.

A customer selects a billboard 26 and a contract period (e.g., one week, one month, three months, etc.) by updating the schedule for the particular billboard 26. The selection of the billboard 26 can also depend on advertising content described in the schedule. The customer can initiate access, retrieval and updates to the schedule using a markup language (e.g., HTML, XML) page that contains reference to common gateway interface (CGI) or a servlet. A CGI is a file written in a programming language (eg., Java, Pearl, C++) that resides in and executes on a server. A servlet is a similar program written in Java. The servlet then manages socket connections to the database, holds session information of the customer, retrieves information from the tables in the relational database, passes information back to the customer and changes the schedule using application programming interfaces (APIs) (e.g., Java Developers Kit (JDK), Java Servlet Developers Kit (JSDK), Remote Method Invocation (RMI), Java Database Connectivity (JDBC), Enterprise JavaBeans (EJB)) available to a programming language (eg., Java 2 Platform Enterprise Edition (J2EE)).

Socket connections that use TCP are maintained until all packets are delivered in the correct order. Thus TCP connections are referred to as “streams” because the packets flow between the sockets until all packets are received because each packet contains information to another packet. Alternatively, some socket connections are opened and closed soon after a packet is received because the packet does not contain ordering information-this is the Universal Datagram Protocol (UDP) approach for sending data. Socket connections that use UDP open and close each time a packet (or Datagram) is received.

On the Internet, TCP/IP is used most because it is a reliable protocol. UDP/IP can be used and sometimes it is preferable because it has less demands on a network server but is not good for critical transfer of information.

As an alternative, the customers can access the schedule from a markup language page that contains client-side and/or server-side Javascript and/or tags to a Java Server Page or a combination of an applet, servlet and CGI. An applet is a file written in the Java programming language and embedded in a markup language file that is downloaded from the server to a client computer and is executed at the client's computer.

RMI is an application programming interface (API) based solely on Java for developing distributed application programs. When using Java to set up socket connections (either by TCP or UDP) and reading and writing information between two sockets, ports are identified and these ports define the protocol to use to read the information. Thus, each port will handle data packets differently and an application protocol is needed at each port to understand the packets. With RMI, the application protocol is not needed. Rather, if the two devices have a java virtual machine, then the machine can handle the request. Thus, data sent does not need to be sent in a certain protocol defined manner.

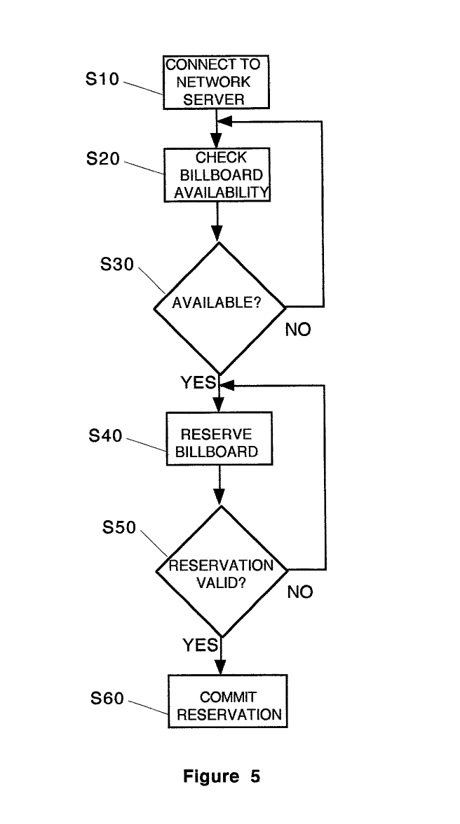

FIG. 5 shows an exemplary flowchart for updating the schedule from a terminal computer 20 or display sites terminal 30. At step S10, the terminal 20, 30 connects with the network server 22 via the Internet as described above. As discussed above, a terminal computer 20 may also be a PDA (e.g. Palm Pilot). A PDA can hotsync either by wireless coupling with a device at the billboard 26 where the PDA communicates via laser, optical or electrical communication at the terminal 20, 30, or by a wire at a terminal 20, 30 to connect to the server 22. As noted above, the PDA can also download information from the sponsor's website or other directory using this hotsync approach. The device at or on the billboard 26 (such as on the billboard screen 56 or on top of the screen) can either actively emit a signal (e.g., EMF signal, etc.) which can be received by the PDA or passively provide access to a link (e.g., a bar code) which the PDA then actively retrieves (e.g., by scanning) to get information and/or instructions from the sponsor and/or link to the sponsor.

Once at the network server 22, an application program is executed to operate the server 22. The customer (or user) checks the availability of a billboard at step S20 by selecting a billboard 26 or a group of billboards 26 that display ads according to the schedule. For each billboard 26 selected, the customer chooses a desired contract period (eg., one day, one week, one month, three months) and a desired start date. The network billboard system 10, via THE application program, validates the input fields and requests corrected information from the customer if the fields are not valid.

Once the fields are validated, the network server 22, and preferably the application server 38, determines the availability of the selected billboard 26 or billboards at step S30.

The server 22 holds the customer-inputted data and connects to the schedule of the selected billboard 26. In accordance with the application program, the network server 22 locates the row matching the customer desired start date. For each column of the matching row, the server 22 searches for an empty cell. Upon locating an empty cell, the program server 22 checks if the contract period can fit thereafter by searching for an empty cell for each following date within the selected contract period. If the contract period cannot fit, then the server 22 searches for an empty cell in an earlier or later date and again checks if the contract period can fit thereafter. These steps are performed for each column. If the server 22 cannot find empty or availably row cells for the contract period beginning with the start date or a nearby start date in any column, then the server 22 links back to step S20 to check the billboard 26 schedule for a different billboard, contract period or start date.

However, if a billboard 26 is available, then the server 22 reserves that billboard at step S40. The customer enters identification and payment information and attaches the advertisement files that the customer desires for display. The advertisement files are named as to identify the customer. The server 22 validates the information and files at step S50. If the information and files are not valid, then the server links back to step S40 and the customer is requested to resubmit the payment information or advertisement files.

Once the information and files are validated, the server 22 commits the reservation at step S60. The server 22 connects to the schedule and updates the schedule by inserting the customer name in the appropriate cells previously located at step S30 for the contract period. The server 22 can also insert other information supplied by the customer describing the files in linked tables as in a relational database. The server 22 transfers the advertising files to a holding area or links the advertising files to a holding area on a data source 32 so that the files can be accessed and displayed per the schedule. Upon completion of the reservation, the server e-mails confirmation of the transaction to the customer.

As disclosed above, the schedule is the routine by which ads are shown. The schedule can be a loop created in a programming language (e.g., Java Script), the sequence of scenes in a moving picture file (e.g., Flash movies) or a table or set of tables in a relational database accessed by the application program. In a preferred embodiment, the application program connects to this relational database, extracts information from the schedule, identifies the advertisement files needed for dissemination, and prepares the advertisement files appropriately for access by the billboard computer. Using this approach, the application server 38 accesses the application program.

The program uses application programming interfaces (APIs) (e.g., Java Developers Kit (JDK), RMI, JDBC, etc.) to manage connections between the datasource 32 and web server 36 after extracting information from the schedule and preparing stored media files for transfer to a working folder. The APIs are used to locate and prepare the stored advertisement files in the data source 32, manage connections between the data source 32 and web server 36, remove expired advertisement files in the working folder (location on a hard drive partition, etc.) on the web server 36, and transfer advertisement files to the working folder on the web server 36.

Moreover, the program can be designed to prepare certain ads on certain billboards based on demographics at specific times and locations. For example, advertisements that target children would run during the times of the day that children would likely be passengers in vehicles (e.g., just before and after normal school hours). Further, advertisements for adults (e.g., alcohol, luxury automobiles, real estate, jewelry, travel) would more likely be shown during evening hours. The program could thereby restrict reservations for certain types of advertisements to preferred locations and times of day in accordance with the demographic and market research data corresponding to the advertisement, as described in greater detail below.

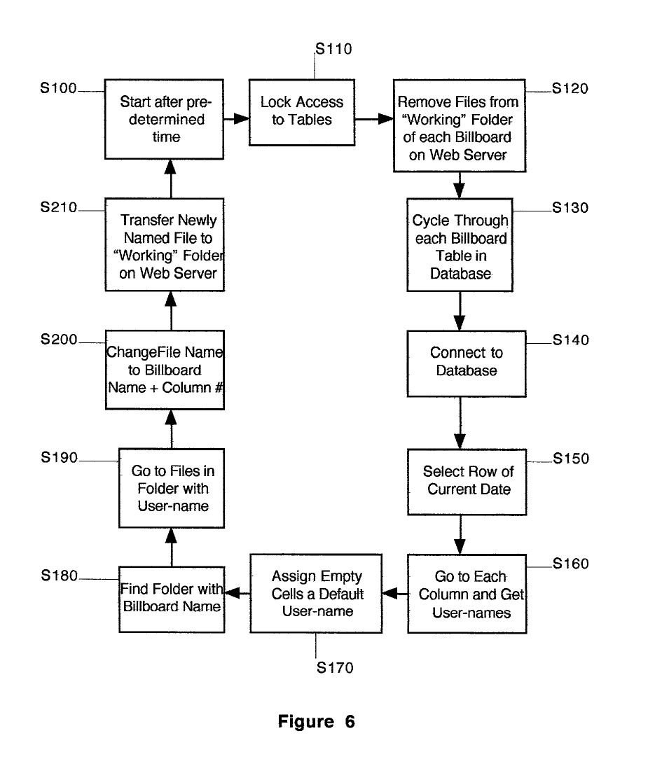

An exemplary distributed programming method which uses the schedule application described above is illustrated at FIG. 6. Peer-to-peer connections between the datasource 32 and web server 36 are managed by the application program. The program accesses the schedule (in the form of database tables) holding scheduling information for each billboard 26, and extracts information from the schedules. The information is extracted using application programming interfaces (APIs) available to a programming language understood by the application program and the database (e.g., Java Database connectivity (JDBC) and Structured Query Language (SQL)). The program then prepares stored media files for transfer to the working folder based on the scheduling information. The stored media files are preferably maintained in the data source 32, and the working folder is preferably maintained at the web server 36. The media files are transferred by renaming, writing and reading data across the sockets. After a predetermined elapsed time of, for example, 24 hours, (step S100), the program locks access to the database tables to prevent customers or users from updating the tables during the execution of this programming loop at step S110. At step S120, the application program accesses a working folder of each corresponding billboard 26 on the web server 36. The working folders contain the media files currently pulled by the billboard computers for display on the billboard 26. Based on the schedule information retrieved by the application program, media files that are no longer scheduled to be displayed are removed from the working folder.

At step S130 of FIG. 6, the program is set up to cycle through each billboard table, preferably in a multi-threaded approach. For each billboard, the program connects to the database and accesses the table corresponding to the billboard at step S140, selects the row of the current date at step S150, and gets the customer names from each cell in the selected row at step S160. At step S170, if a cell in the row is empty, then the program assigns a default customer name corresponding to a default ad. An example of a default ad would be an ad from a customer that buys the available slots at a bulk rate, or an advertisement that additional advertising space is available at this billboard. At step S180, the application program locates the stored media files in the hard drive location on the data source 32 corresponding to the billboard 26. In this folder are the media files transferred for example by a customer from a terminal 20, 30.

As described above, the advertisement files are named as to identify the customer. Continuing with the method shown in FIG. 6, the application program at step S190 finds the files that match the customer information extracted from the schedule, copies the file, and renames the file at step S200. The files are renamed at step S200 to reflect the sequence (taken from the column number in the schedule) and path (taken from the billboard name) by which the billboard computer software can locate and pull the advertisement file for display. After the files are renamed, the application program transfers the file to the appropriate hard drive location on the web server 36 (i.e., “working” folder) at step S210 for access by the billboard computer 28.

As described above, market research and demographic data can be included by a sponsor of an advertisement file. The additional information can be supplied at step S20 of FIG. 5. At step S20, a sponsor of an ad may also have the option to select from a list of categories and descriptions regarding the advertisement, such as those disclosed in Table 1. Selections can be made by, for example, pull down menus or radio boxes. These selections can be committed to a market research table as described above and in step S60 of FIG. 5 along with the advertisement file supplied by the customer.

The market research table is particularly useful in a multi-billboard system. In a peer-to-peer model of communication, each billboard computer 28 can have both client and server functionality. Thus, the exemplary application program method described herein can feasibly reside on each billboard computer 28 and proceed through steps S100 through S210 with some modification as described below. For example, if a billboard 26 is located near a school and it is known that many mothers and children will pass the billboard 26, then at step S100 the application program may activate after an elapsed time such as at 2 o'clock every day when school is closing. The application program will access the billboard's working folder on the web server 36 in step S120 to remove files in preparation of receiving new advertisement files for display to a targeted audience. At step S130, instead of cycling through all billboard tables, the application will access the market research table, similar to Table 1, holding the market research information. At step S140, the program connects to the database, which, in this example, includes data from Table 1. Then at step S150, the program selects a column, such as the “Goods/service sector” column shown in Table 1, and compiles a list of all customer names in a category, such as “Home Care.” Other boolean search combinations can also be used. For example, the program can extract customer names in the categories that match Goods/service sector “Home Care” AND age group 6 to 15 years. If the number of matches from the search is less than the desired operating capacity of the billboard 26, default advertisements can be used to fill in leftover space at step S170. The program then proceeds through steps S180 to S210 to locate the files, rename the files (e.g., with the billboard name on which the application program resides and a sequential number) and transfers the files to the web server 36 for display at the billboard 26. Consequently, with this exemplary feature, while a customer's preferred choice of billboard may not be available, the customer may still have an advertisement displayed if the advertisement meets search criteria appropriate for the billboard location and time.

The billboard computer software (e.g., Netscape) connects to the web server and pulls markup language files (e.g., web pages) that reference media files. The markup language files code the images that will be displayed as, for example, the client-side Javascript loop and/or applet for animated GIFs, and/or contain tags to embed a moving picture file (e.g., Macromedia Flash movie). These markup language files are preferably kept in a folder on the web server 36 and in practice, several billboard computers 28 can point to the same folder thereby pulling the same set of markup language files. Moreover, each billboard computer 28 can have its own folder and set of markup language files. Also, these markup language files may contain tags to pull (“client pull”) other pages in a loop where the next mark up language page references another media file and a tag to another mark up language page, etc. so that an entire set of markup language files are in a cycle.

For example, the HTML tag below, placed in the Header section of an HTML file, will “pull” the web page, “billboardlad2.HTML,” located on the “NBSwebserver” to the Billboard computer after 15,000 milliseconds has elapsed. In turn, that page will pull Page 3, and Page 3 will pull Page 4, etc., and the 40th page will return to the beginning, Page 1, by pulling the web page “billboardladl.HTML.”

<META HTTP-EQUIV=“Refresh” CONTENT=“15000;

URL=http:// NBSwebserver/billboardlad2.HTML”>

Further, the HTML tag below, placed in the Body section of the same HTML file, will reference an animation file, such as the Shockwave Flash movie file (billboardladl.swf) from the “billboardlworking folder.”

<EMBED Play=true>billboardlworkingfolder/billboardladl.swf <EMBED>

Also, the HTML tag below, placed in the Body section of the same HTML file, will reference the applet file (billboardladl.class) from the “billboardl workingfolder” that refers to an animated GIF.

<APPLET CODE=“billboardlworkingfolder/billboardladl.class”

WIDTH=“200”>

</APPLET>

Alternatively, markup language files may reference other supporting client-side (e.g., Client-side Javascript, Applets) and server-side (e.g., Server-side Javascript, servlets, CGI, etc.) files to activate the web server 36 to push new media files back to the billboard computer 28 (“server push”).

The network billboard system 10 can also operate using a more simplified approach. In this approach, an application program does not automatically and directly prepare the files for access by the billboard computer. Here, an application program allows customers to access and update a schedule table as in a relational database. However, instead of an application program automatically accessing the schedule to locate, copy, rename, and transfer files as described above, the schedule can be manually accessed (e.g., printed by personnel (such as a network administrator) and used to manually configure the files as described above for the automatic scenario.

Alternatively, a media technician could combine the content of several advertisement files from different customers into one animated GIF sequence or moving picture file in an order based on the schedule. For example, a media technician can extend the Javascript loop coded on a markup language file or applet embedded in the markup language file to accommodate the additional scenes for the animated GIF. As another example, a media technician can use media creation software (e.g., Macromedia Flash) to import the different files, arrange the scenes to appear according to the schedule and save the merged content as one file. This one file could then be transferred to the web server 36 and referenced in a markup language file for eventual dissemination by the billboard computer 28.

The terminal computer 20 and display site terminal30 permit a customer or user to schedule a billboard, include description of advertisement target, transfer files, process payment transactions, and view and/or download information from the sponsor's website, as described above. As described above, PDA computing protocols and technology can also be incorporated into the terminals 20,30. With this technology, individuals (e.g., customers, users, observers) can hotsync their PDA either by wireless or wired communication. Using the PDA, an individual connects to a port on the terminal 20, 30 and downloads desired information (e.g., scheduling information, information from a sponsor's website). Also the PDA can use infrared technology to connect to an infrared accessible location and device at the billboard 26 to download the desired information. The desired information includes any kind of information that can be transferred over a wireless port, including a markup language page, a GIF file, or other files that can be communicated over a protocol (e.g., TCP/IP).

It should be apparent from the aforementioned description and attached drawings that the concept of the present application may be readily applied to a variety of preferred embodiments, including those disclosed herein. For example, multiple billboard computers are not a requirement for the NBS. A single billboard computer 28 can be connected to the network server 22 either by wire or wireless communication and either geographically distant or in close proximity thereto. Communication between these computing devices (e.g., billboards, billboard computers, servers, data sources) either manually and/or automatically by the application program is part of the administration, delivery and dissemination of the data described above.

In addition, there are different distributed programming techniques available, such as, the use of socket programming, remote method invocation, mobile agents, and JINI. Combinations of these techniques along with multi-threading techniques can also be used, as the different techniques allow varying degrees of accessing and using data, hardware, computing cycles, and software on different computers with possibly different operating systems and electronic devices to perform tasks synergistically. However, as will be appreciated by those skilled in the art, the application program does not have to be distributed to be within the scope of the invention. For example, a billboard computer 28 can have an application program or programs installed that is able to access a file within the same computer for a display according to a schedule. Moreover, the operation of a billboard 26 can be provided in an isolated manner and does not need to be restricted to the described embodiment, since the embodiments described are exemplary. Further, the billboard computer 28 is not restricted to the exemplary hardware models, operating systems, or web browser software identified. Hardware and software considerations depend on the additional functionalities desired for the billboard or billboards. For example, in a peer-to-peer configuration, the billboard computers will have application beyond importing and interpreting markup language tags and applet files. As the functions of the billboard computer 28 and level of user interface become more sophisticated, the operating system, hardware requirements, and application programs for the billboard computer 28, network server 22, and data sources 32 may changes as understood by a skilled artesian.

A skilled artesian will also understand that the NBS 10 may be provided without customer functionality directly incorporated. For example, database tables could be the domain of specific personnel to update without having the tables accessible to customers as previously described. Moreover, the NBS 10 need not be limited to only the display of information to a billboard but also the other devices. For instance, global positioning systems (GPSs) are used within an application to determine if a person is within a particular target of interest. The application sends a voice-mail message or e-mail message to that person as he or she approaches the target. Such a system and application could be combined with the NBS to disseminate data to a person's cell phone, beeper, PDA, or other mobile display device as the person approaches a particular billboard 26. In this manner, the advertisement is disseminated to both the billboard 26 and the person's mobile display device.

The network billboard system 10 is generally described above as retrieving information from the server 22 in a client-server model where the billboard computer 28 is the client requesting information from a central location (e.g., a web page containing an advertisement from the server 22). However, since all of the billboards 26 are indirectly or directly interconnected, server applications can be placed on the billboard computers 28.

In this arrangement, a billboard computer 28 can essentially bypass the server 22 and connect to another billboard computer 28 for information based on a triggering event (e.g., a schedule). In this scenario, the billboard computers 28 not only request information, but serve information, thereby relieving the requirement of a central location. This configuration is disclosed above as a peer-to-peer model. In summary, the supporting configuration of the network billboard system can use a client-server methodology but is not limited thereto. As with the client-server model discussed above, a peer-to-peer model can be incorporated to execute the utility of the network billboard system within the scope of the embodiments.

Without further elaboration, the foregoing will so fully illustrate our invention that others may, by applying current or future knowledge, adopt the same for use under various conditions of service.

I claim:

1. A method for reserving advertisement space for a customer in a network billboard system including a network controller in communication with at least one electronic billboard and a storage device, the method comprising:
receiving a request to reserve an advertising space via the network controller, the request including a desired one of the at least one electronic billboard a desired start date and a desired contract period;
locating a billboard schedule in the storage device for the desired billboard in accordance with the request;
determining whether the desired billboard has an available slot on the desired start date or finding an available slot on a date closest to the desired start date based on the request;
reserving the available slot corresponding to the desired start date or the date closest to the desired start date; and
committing the available slot for the desired contracted period.

2. The method of claim 1, further comprising notifying the customer that the transaction is confirmed.

3. The method of claim 1, further comprising processing customer payment information to bill the customer.

4. The method of claim 1, further comprising identifying market data associated with the customer in accordance with the billboard schedule, and confirming the available slot based on the market data, the market data including information identifying a target group for an advertisement from the customer.

5. The method of claim 1, further comprising requesting to transfer an advertisement file of the customer to the at least one electronic billboard for display according to the billboard schedule.

6. A system for reserving advertisement space for a customer in a billboard network, the network including a network controller in communication with at least one electronic billboard and a storage device, the system comprising:
means for receiving a request to reserve an advertising space via the network controller, the request including a desired one of the at least one electronic billboard a desired start date and a desired contract period;
means for locating a billboard schedule in the storage device for the desired billboard in accordance with the request;
means for determining whether the desired billboard has an available slot on the desired start date or finding an available slot on a date closest to the desired start date based on the request;
means for reserving the available slot corresponding to the desired start date or the date closest to the desired start date; and
means for committing the available slot for the desired contracted period.

7. The system of claim 6, further comprising means for notifying the customer that the transaction is confirmed.

8. The system of claim 6, further comprising means for processing customer payment information to bill the customer.

9. The system of claim 6, further comprising means for identifying market data associated with the customer in accordance with the billboard schedule, and means for confirming the available slot based on the market data, the market data including information identifying a target group for an advertisement from the customer.

10. The system of claim 6, further comprising means for requesting to transfer an advertisement file of the customer to the at least one electronic billboard for display according to the billboard schedule.

11. An executable program for reserving advertisement space for a customer in a network billboard system including a network controller in communication with at least one electronic billboard and a storage device, the program comprising:
a first source code segment for receiving a request to reserve an advertising space via the network controller, the request including a desired one of the at least one electronic billboard a desired start date and a desired contract period;
a second source code segment for locating a billboard schedule in the storage device for the desired billboard in accordance with the request;
a third source code segment for determining whether the desired billboard has an available slot on the desired start date or finding an available slot on a date closest to the desired start date based on the request;
a fourth source code segment for reserving the available slot corresponding to the desired start date or the date closest to the desired start date; and
a fifth source code segment for committing the available slot for the desired contracted period.

12. The executable program of claim 11, further comprising a sixth source code segment for notifying the customer that the transaction is confirmed.

13. The executable program of claim 11, further comprising a sixth source code segment for processing customer payment information to bill the customer.

14. The executable program of claim 11, further comprising a sixth source code segment for identifying market data associated with the customer in accordance with the billboard schedule, and a seventh source code segment for confirming the available slot based on the market data, the market data including information identifying a target group for an advertisement from the customer.

15. The executable program of claim 11, further comprising a sixth source code segment for requesting to transfer an advertisement file of the customer to the at least one electronic billboard for display according to the billboard schedule.

16. The executable program of claim 11, further comprising a sixth source code segment for processing customer payment information to bill the customer.

17. The executable program of claim 11 embodied on a computer readable medium.

18. A computer data signal for reserving advertisement space for a customer in a network billboard system including a network controller in communication with at least one electronic billboard and a storage device, the data signal comprising:
a first signal segment for receiving a request to reserve an advertising space via the network controller, the request including a desired one of the at least one electronic billboard a desired start date and a desired contract period;
a second signal segment for locating a billboard schedule in the storage device for the desired billboard in accordance with the request;
a third signal segment for determining whether the desired billboard has an available slot on the desired start date or finding an available slot on a date closest to the desired start date based on the request;
a fourth signal segment for reserving the available slot corresponding to the desired start date or the date closest to the desired start date; and
a fifth signal segment for committing the available slot for the desired contracted period.

19. The computer data signal of claim 18, further comprising a sixth signal segment for notifying the customer that the transaction is confirmed.

20. The computer data signal of claim 18, further comprising a sixth signal segment for processing customer payment information to bill the customer.

21. The computer data signal of claim 18, further comprising a sixth signal segment for identifying market data associated with the customer in accordance with the billboard schedule, and a seventh signal segment for confirming the available slot based on the market data, the market data including information identifying a target group for an advertisement from the customer.

22. The computer data signal of claim 18, further comprising a sixth signal segment for requesting to transfer an advertisement file of the customer to the at least one electronic billboard for display according to the billboard schedule.

23. The computer data signal of claim 18, further comprising a sixth signal segment for processing customer payment information to bill the customer.

24. A distributed programming method for placing advertisements in a network billboard system including a network controller in communication with at least one electronic billboard, the method comprising;
accessing a schedule table for at least one of the electronic billboards, the table having an identification of customers for time slots over a list of dates;
locating an advertisement file corresponding to the customer identified in a time slot;
transmitting an advertisement signal to the billboard, the advertisement signal indicating a media file for display at the billboard based on the advertisement file corresponding to the time slot; and
upon receipt of a request from a party, providing access to information of goods or services provided by the customer, the access provided to the requesting party.

25. The method of claim 24, the advertisement signal comprising a markup language file that embeds or references advertisement files as the media file for display.

26. The method of claim 24, the access to information comprising a link to the web site of the customer.

27. The method of claim 24, further comprising accessing a customer table having market and demographic data associated with the identification of the customers, the market data including information identifying a target group for an advertisement from the customers, and revising the schedule table according to the market data.

28. A networked billboard system for displaying advertisements, the billboard system including a network controller in communication with at least one electronic billboard and a storage device, the system comprising;
means for accessing a schedule table for at least one of the electronic billboards, the table having an identification of customers for time slots over a list of dates;
means for locating an advertisement file corresponding to the customer identified in a time slot;
means for transmitting an advertisement signal to the billboard, the advertisement signal indicating a media file for display at the billboard based on the advertisement file corresponding to the time slot; and
upon receipt of a request from a party, means for providing access to information of goods or services provided by the customer, the access provided to the requesting party.

29. The system of claim 28, the network controller comprising a computer in communication with the at least one billboard.

30. The system of claim 28, the advertisement signal comprising a markup language file that embeds or references advertisement files as the media file for display.

31. The system of claim 28, the access to information comprising a link to the web site of the customer.

32. The system of claim 28, further comprising means for accessing a customer table having market and demographic data associated with the identification of the customers, the market data including information identifying a target group for an advertisement from the customers, and means for revising the schedule table according to the market data.

33. An executable program for placing advertisements in a network billboard system including a network controller in communication with at least one electronic billboard and a storage device, the program comprising;
a first source code segment for accessing a schedule table for at least one of the electronic billboards, the table having an identification of customers for time slots over a list of dates;
a second source code segment for locating an advertisement file corresponding to the customer identified in a time slot;
a third source code segment for transmitting an advertisement signal to the billboard, the advertisement signal indicating a media file for display at the billboard based on the advertisement file corresponding to the time slot; and
a fourth source code segment for providing access to information of goods or services provided by the customer upon receipt of a request from a party, the access provided to the requesting party.

34. The executable program of claim 33 embodied on a computer readable medium.

35. The executable program of claim 33, the advertisement signal comprising a markup language file that embeds or references advertisement files as the media file for display.

36. The executable program of claim 33, the access to information comprising a link to the web site of the customer.

37. The executable program of claim 33, further comprising a fifth source code segment for accessing a customer table having market and demographic data associated with the identification of the customers, the market data including information identifying a target group for an advertisement from the customers, and a sixth source code segment revising the schedule table according to the market data.

38. A computer data signal for placing advertisements in a network billboard system including a network controller in communication with at least one electronic billboard and a storage device, the data signal comprising;
a first signal segment for accessing a schedule table for at least one of the electronic billboards, the table having an identification of customers for time slots over a list of dates;
a second signal segment for locating an advertisement file corresponding to the customer identified in a time slot;
a third signal segment for transmitting an advertisement signal to the billboard, the advertisement signal indicating a media file for display at the billboard based on the advertisement file corresponding to the time slot; and
a fourth signal segment for providing access to information of goods or services provided by the customer upon receipt of a request from a party, the access provided to the requesting party.

39. The computer data signal of claim 38, the advertisement signal comprising a markup language file that embeds or references advertisement files as the media file for display.

40. The computer data signal of claim 38, the access to information comprising a link to the web site of the customer.

41. The computer data signal of claim 38, further comprising a fifth signal segment for accessing a customer table having market and demographic data associated with the identification of the customers, the market data including information identifying a target group for an advertisement from the customers, and a sixth signal segment revising the schedule table according to the market data.

42. A programming method for a dynamic schedule application, the method comprising:
(a) accessing a schedule having scheduling information for an electronic billboard;
(b) accessing a storage folder of the billboard, the folder having media files that are scheduled to be displayed;
(c) in the schedule, selecting a row of the current date and receiving a customer identification from each cell in the selected row;
(d) locating the stored media files corresponding to the customer identification; and
(e) renaming the corresponding stored media files to reflect the scheduled sequence of the media files for display at the billboard.

43. The programming method of claim 42, further comprising transferring the renamed corresponding stored media files to a local folder for quicker access, and restricting further access to the schedule during steps (b) through (e) to prevent revisions to the schedule during steps (b), (c), (d) and (e).

44. A programming method for a dynamic schedule application, the method comprising:
(a) accessing a database having scheduling information for at least one electronic billboard;
(b) identifying market data associated with a customer, the market data including information identifying a target group for an advertisement from the customer;
(c) searching the database for an unassigned time slot available for the target group that matches the market data associated with the customer, the unassigned time slot corresponding to one of the at least one billboard;
(d) assigning the unassigned time slot to the customer;
(e) locating a media file corresponding to the customer; and
(f) linking the media file to the assigned time slot for display at the one billboard according to the database.

45. A network billboard system comprising a billboard computer in communication with at least one billboard and a network server, the billboard computer including a central processing unit that processes data and operations required to run the billboard computer, a communication conduit for communication with the at least one billboard, a memory to store and buffer data used by the central processing unit, and a network interface that provides the communication medium with the network server, the network interface providing means for the billboard computer to retrieve language files from the network server that embed or reference advertisement files or programs according to a schedule, the communication conduit providing means for transmitting the scheduled advertisement files or programs to the at least one billboard for displaying an advertisement.

46. The network billboard system of claim 45, the network server being at least one computer that serves the language files to the billboard computer.

47. The network billboard system of claim 45, the network server being a second billboard computer in communication with both a second billboard and said billboard computer.

48. The network billboard system of claim 45, the network server including a web server and an application server.

49. The network billboard system of claim 45, the network server accessing a schedule for the at least one billboard, the schedule having an identification of customers for time slots for future dates, the identification being an indicia of source for the scheduled advertisement files.

50. The network billboard system of claim 45, the network server accessing a table for the at least one billboard, the table having descriptions of the advertisement files or programs for targeted advertisement.

51. A network billboard system, comprising a network server in communication with at least one billboard and a data source, the network server executing an application program that forwards advertising files to the at least one billboard, the network server retrieving language files from the data source, the language files embedding or referencing the advertisement files according to a schedule and providing the advertisement files for communication to the at least one billboard for display.

52. The network billboard system of claim 51, the network in communication with an end user via an input device, the network accessing and revising the schedule based on instructions from the end user.

53. The network billboard system of claim 51, the network server in communication with the at least one billboard via the internet and a billboard computer.
